(19) United States
(12) Patent Application Publication
(10) Pub. No.: US 2007/0181474 A1
(43) Pub. Date: Aug. 9, 2007

(54) Filter for a microbe reactor of sewage treatment

(75) Inventor: Winston Lin, Taichung (TW)

Correspondence Address: BRUCE H. TROXELL, SUITE 1404, 5205 LEESBURG PIKE, FALLS CHURCH, VA, 22041, US

(73) Assignee: Union Looper Co., Ltd.

(21) Appl. No.: 11/346,355

(22) Filed: Feb. 3, 2006

(51) Int. Cl. C02F 3/06

(52) U.S. Cl. 210/150

(57) ABSTRACT

A filter for a microbe reactor of sewage treatment installed in the microbe reactor is provided with innumerable irregular ringed filaments twisted together and piled up mutually and innumerable interspaces formed among the irregular ringed filaments. Each irregular ringed filament is provided with lots of recesses all over the surface for natural microbes to attach and proliferate thereon, so as to decompose organic compounds in the sewage effectively.

### BACKGROUND OF THE INVENTION

1. Field of the Invention

This invention relates to a filter, particularly to one installed in a microbe reactor, able to filtrate sewage and grow abundant natural microbes to decompose organic compounds.

2. Description of the Prior Art

Commonly, a sewage treatment, especially for house or building sewage, includes a static precipitation, a treatment of microbe decomposition and even plural processes of aeration and disinfections, so as to achieve a complete sewage treatment for reducing contamination to rivers and improving the quality of life.

A conventional treatment of microbe decomposition is carried out in a microbe reactor that is installed with a microbe turntable inside it, used as a medium to let particular microbe attach and proliferate so as to decompose the sewage. Although microbe can infest and proliferate on the microbe turntable, but the area of the microbe turntable is always too small to be attached, so that the treatment takes a rather long time owing to a low growth of the microbe. Moreover, the microbe turntable has to be driven by power, causing a higher cost.

### SUMMARY OF THE INVENTION

The prime object of this invention is to offer a filter for a microbe reactor of sewage treatment.

The filter installed in a microbe reactor is provided with innumerable irregular ringed filaments twisted together and piled up mutually and innumerable interspaces formed among the irregular ringed filaments, able to filtrate sewage. Each irregular ringed filament is provided with lots of recesses all over the surface for natural microbes to attach and proliferate thereon, so as to decompose the organic compounds in the sewage effectively.

### BRIEF DESCRIPTION OF DRAWINGS

This invention is better understood by referring to the accompanying drawings, wherein:

FIG. 1 is a perspective view of a preferred embodiment of a filter for a microbe reactor of sewage treatment in the present invention;

FIG. 2 is a partial magnified view of an irregular ringed filament in the filter in the present invention; and

FIG. 3 is a side cross-sectional view of the filters in the present invention installed in microbe reactors.

### DETAILED DESCRIPTION OF THE PREFERRED EMBODIMENT

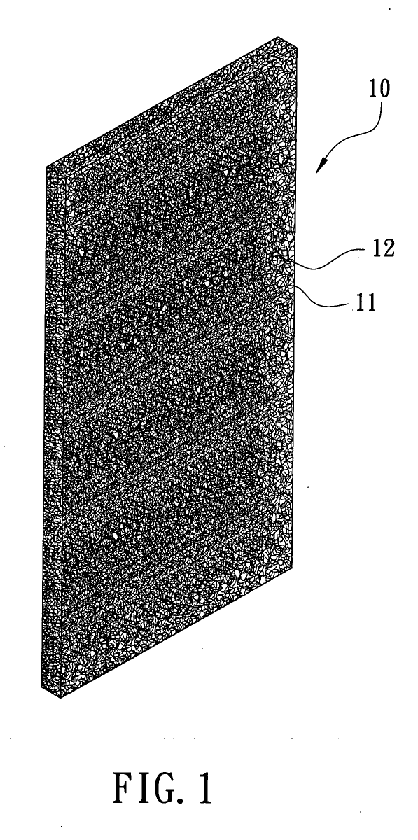

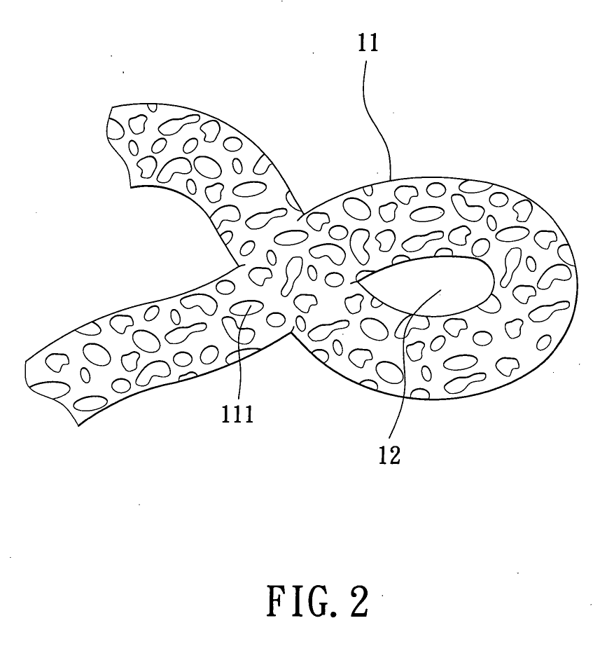

As shown in FIGS. 1 and 2, a preferred embodiment of a filter 10 for microbe reactor of sewage treatment in the present invention is provided with innumerable irregular ringed filaments 11 and innumerable tiny interspaces 12.

The filter 10 is formed as a block of a preset shape.

The irregular ringed filaments 11 made of thermoplastic polymer via thermo squeezing are mutually twisted together and piled up. In addition, there are also innumerable irregular recesses 111 with different depths spread on the surface of each irregular ringed filament 11.

The tiny interspaces 12 are formed among the irregular ringed filaments 11.

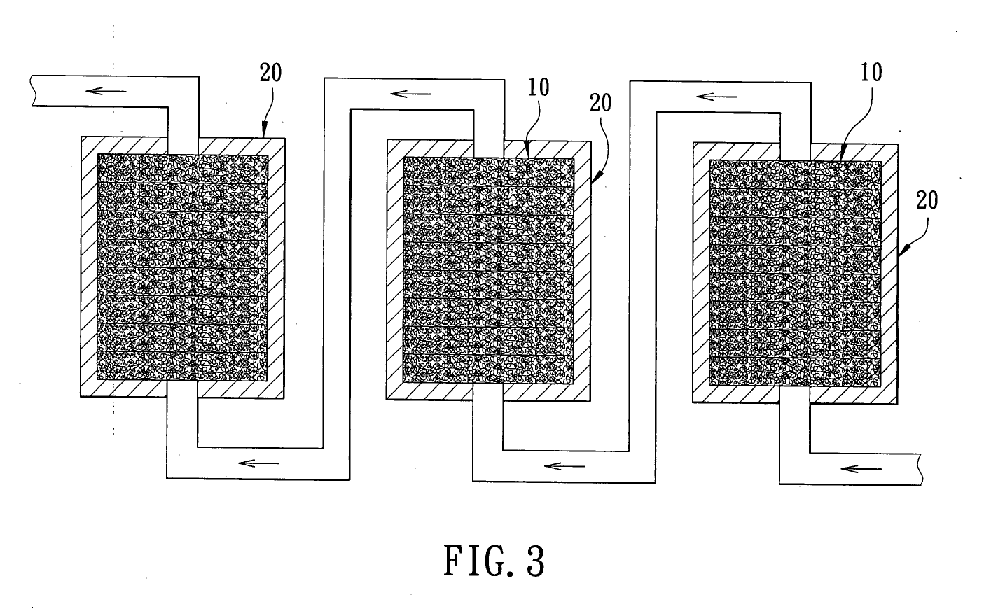

In using, as shown in FIG. 3, plural filters 10 in the present invention can be piled up in each microbe reactor 20 of a sewage treatment plant, so the filters 10 can not only filtrate sewage coming from precipitating tanks or other tanks, flowing through the bottom of the microbe reactor 20 to the top by means of the irregular ringed filaments 11 and the interspaces 12 among the irregular ringed filaments 11, but also decompose organic compounds in the sewage by lavish natural microbes proliferating on the recesses 111 of the irregular ringed filaments 11, achieving a very effective and quick decomposition. In addition, because the filaments 11 of the filter 10 are twisted together and piled up irregularly, so the interspaces 12 are spread irregularly as well so that sewage flows hither and thither to enhance contact with the recesses 111, ensuring a more rapid decomposition certainly.

While the preferred embodiment of the invention has been described above, it will be recognized and understood that various modifications may be made therein and the appended claims are intended to cover all such modifications that may fall within the spirit and scope of the invention.

What is claimed is:

1. A filter for a microbe reactor of sewage treatment:
said filter, as a main body, formed as a block of a preset shape and composed of innumerable irregular ringed filaments made of thermoplastic polymer via thermo squeezing and mutually twisted together and piled up, each said irregular ringed filament spread with innumerable recesses on the surface, and innumerable interspaces formed among said irregular ringed filaments for sewage to flow through.

2. A filter for a microbe reactor of sewage treatment as claimed in claim 1, wherein said recesses are formed irregular and have different depths.
